(19) United States
(12) Patent Application Publication
(10) Pub. No.: US 2025/0230033 A1
(43) Pub. Date: Jul. 17, 2025

(54) APPARATUS FOR IMPROVED TRANSFER AND STORAGE OF VISCOUS FLUIDS

(71) Applicant: Limworks, LLC, Ludington, MI (US)

(72) Inventor: John E. Burton, Ludington, MI (US)

(21) Appl. No.: 18/850,827

(22) PCT Filed: Mar. 16, 2023
(86) PCT No.: PCT/US2023/015366

§ 371 Date: Sep. 25, 2024

Related U.S. Application Data
(60) Provisional application No. 63/326,314, filed on Apr. 1, 2022.
(60) Provisional application No. 63/352,685, filed on Jun. 16, 2022.

(51) Int. Cl. B67D 7/64; B65B 3/12

(52) U.S. Cl. CPC B67D 7/645; B65B 3/12

(57) ABSTRACT

A fluid transfer apparatus for transferring fluid from a bulk storage container to a secondary container, such as from a pail to a cartridge. The apparatus may include a vertical press and a modular follower plate. The modular follower plate may be affixed to the vertical press such that the vertical press can be operated to force the modular follower plate progressively farther down into the bulk storage container. The modular follower plate may include a secondary container seat upon which a secondary container is fitted for filling. The modular follower plate may include a through-hole that allows fluid disposed below the modular follower plate to be forced upwardly into the secondary container as the modular follower plate is press downwardly into the fluid with the bulk storage container. The modular follower plate may include a circumferential seal that engages the inner surface of the bulk storage container.

### FIELD OF INVENTION

The present invention relates to an apparatus for the transfer of viscous fluid material from a drum, pail or other bulk storage to a smaller container, such as a cartridge, for dispensing.

### BACKGROUND OF THE INVENTION

Numerous higher viscosity fluids such as but not limited to liquid silicone rubber, adhesives, and grease are sold in bulk containers such as drums, pails or jars from which the fluid is eventually transferred to a smaller container for use. These types of viscous fluids are often not pourable, difficult to clean and transfer from one container to another. Container pails come in sizes such as but not limited to 1, 2, 3.5, 5, 6 and 7 gallon. Some pails are metal and include plastic liners. Other pail containers are manufactured by conventional injection molding processes which require a tapered inner diameter or a ‘draft angle’. Transferring viscous fluid from a drum, pail or jar to a smaller container such as a cartridge with piston commonly ranging from 6 oz to 32 oz is often needed for mixing, dispensing or re-packaging. Cartridges are often plastic and manufactured by injection molding. However, since a floating plunger or ‘piston’ is also used to push material out of the cartridge the inner diameter of the cartridge needs to be straight with ‘zero draft’ for the piston to function and manufacturing this requires a more sophisticated injection molding process. The piston and cylinder help determine the volume of material dispensed which is especially important for mixing materials like adhesives or silicones. Knowing the volume of material dispensed eliminates the extra steps needed to weigh these materials on a scale for mixing since the density is known.

One conventional option to transfer material out of a drum, pail or jar is to use a pumping system. This involves getting the viscous fluid fed into a pump such as piston, diaphragm or gear pump which provides the pressure needed to transfer the fluid into the cartridge often through hoses or tubing. The problem with this method is that it is primarily intended for transferring large quantities. The process is labor intensive to set up and clean the system for use with another viscous fluid material. Priming the system and clean up also wastes material. This method is not cost effective if the goal is to fill only one or a couple of cartridges at a time. Graco and ARO are some manufactures of these types of pumping systems.

Another conventional option is to attempt to pour or use a utensil to scoop the viscous fluid out of a pail and put it into the cartridge. One problem with this method is that it introduces air along with the viscous fluid inside the cartridge. This is often a very messy process that can create waste and requires clean up.

Another conventional option involves using a follower plate that has an outer diameter that closely fits the inside diameter of the pail and a center sleeve with material port that the cartridge is placed on for filling. Once the follower plate and cartridge are inserted into the pail a vacuum is then applied to the open end of the cartridge. The vacuum draws viscous fluid into the cartridge through the material port. Some follower plates have flexible perimeter seals that act to wipe the sides of the pail while others don't and allow some leakage. Regardless, there are several problems with this system.

One problem is after the cartridge is filled removing it from the vacuum follower plate sleeve ‘stretches’ viscous fluid in an hour glass shape as it is separated. This is also known as a viscoelastic liquid bridge. The center of the liquid bridge becomes very narrow at the point of separation and collapses under gravity. The end result is a mess to clean and the potential air entrapment as the cartridge piston is installed in the end of the cartridge.

Another problem is after a cartridge is filled by vacuum the follower plate can't be easily removed because it is ‘stuck’ to the viscous fluid inside the pail. Even after the follower plate is removed cleaning fluid material off is time consuming and wastes material. Leaving the follower plate in the pail to avoid this cleaning often results in the plate slowing sinking into the viscous fluid and becoming submerged. When this happens fluid gets on the top surface of the follower plate and not usable until removed and cleaned.

Another problem is that some cartridges are not designed for withstanding vacuum pressure and will implode under heavy vacuum shattering the cartridge.

Further, adhesives and other viscous fluids that react with air trapped inside the pail can result in a reduced shelf during storage.

Accordingly, there remains a need for an improved system for transferring viscous fluids from bulk storage to smaller containers.

### SUMMARY OF THE INVENTION

The present invention provides a fluid transfer apparatus for transferring fluid from a bulk storage container to a secondary container. The bulk storage container may be a pail and the secondary container may be a cartridge. The apparatus may include a vertical press and modular follower plate. The modular follower plate may be affixed to the vertical press such that the vertical press can be operated to force the modular follower plate progressively farther down into the bulk storage container.

In one embodiment, the modular follower plate may include a secondary container seat, such as a cartridge seat, upon which a secondary container is fitted for filling.

In one embodiment, the modular follower plate may include a through-hole that allows fluid disposed below the modular follower plate to be forced upwardly into the secondary container as the modular follower plate is press downwardly into the fluid with the bulk storage container.

In one embodiment, the modular follower plate includes a circumferential seal that engages the inner surface of the bulk storage container and creates a seal therebetween to resist the flow of fluid through the interface between the modular follower plate and the bulk storage container, thereby facilitating the flow of fluid up through the through-hole and into the secondary container.

In one embodiment, the modular follower plate includes a top plate, a bottom plate, a secondary container adapter (e.g. a cartridge adapter) and a circumferential seal. The top plate and bottom plate may be configured to cooperatively define a circumferential channel in which the circumferential seal is seated.

In one embodiment, the secondary container adapter is interchangeable fitted into the modular follower plate, thereby allowing the modular follower plate to be fitted with different secondary container adapters configured to seat and fill different types of secondary containers.

In one embodiment, the seal is configured with a high degree of compressibility so that it can provide an effective seal against the inner wall of the bulk storage container even when the bulk storage container was formed with a draft angle that varies the inner diameter of the bulk storage container.

In one embodiment, the rigid portions of the modular follower plate (e.g. the top plate and the bottom plate) each have a diameter that is small enough to allow the modular follower plate to be moved to a position immediately adjacent to the bottom of the bulk storage container to minimize the amount of fluid that remains in the bottom of the bulk storage container.

In one embodiment, the fluid transfer apparatus includes a secondary container holder (e.g. cartridge holder) that holds and facilitates movement of a secondary container during filling and insertion of a piston into a filled secondary container.

In one embodiment, the fluid transfer apparatus includes a piston holder that is configured to hold a secondary container piston and is positioned where the secondary container holder can be used to move the secondary container onto the piston to close the open bottom end of the filled container.

In one embodiment, the secondary container holder is mounted to the vertical press and is movable both vertically and radially with respect to the vertical press.

In one embodiment, the secondary container holder allows the secondary container to be moved down onto the secondary seat for filling, up off of the secondary seat after it is filled, radially into vertical alignment with the piston holder, down onto a piston seated on the piston holder and then up to remove the secondary container with installed piston from the piston seat.

In one embodiment, the secondary container holder includes a mechanism for deforming the bottom end of the secondary container so that air can escape when the secondary container is fitted down onto the piston.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 shows an isometric view of machine press 100.

FIG. 2 shows an isometric view of the machine press 100, pail 70 and modular follower plate 200.

FIG. 3 shows sections and an isometric view of the modular follower plate 200.

FIG. 4 and FIG. 5 shows sections of two different modular follower plate 200 configurations with cartridges attached.

FIG. 6 shows the modular follower plate 200 as stored inside a pail.

FIG. 7 shows isometric view of the machine press 100, pail 70 and cartridge 82 being filled.

FIG. 8 shows several views of a cartridge holder 300 that may be used on the machine press 100.

FIG. 9 shows the cartridge holder 300 on the machine press 100 and a cartridge 82 being filled.

FIG. 10 shows the cartridge 82 being lifted off using the cartridge holder 300.

FIG. 11 shows the cartridge 82 being positioned over a piston using the cartridge holder 300.

FIG. 12 shows a piston 29 being inserted into the cartridge 82 using the cartridge holder 300.

FIG. 13A is a front view of an alternative machine press in accordance with an alternative embodiment of the present invention.

FIG. 13B is a sectional view of a portion of the alternative machine press take along line A-A of FIG. 13A.

FIG. 14 is a perspective view of the alternative machine press of FIG. 13A without the follower plate.

FIG. 15A is a perspective view of the alternative machine press similar to FIG. 14, except with the alternative follower plate installed.

FIG. 15B is an enlarged view of Section E of FIG. 15.

FIG. 16A is an exploded perspective view of the alternative follower plate.

FIG. 16B is an enlarged perspective view of Area C of FIG. 16A.

FIG. 16C is an enlarged perspective view of Area D of FIG. 16A.

FIG. 17A is a top plan view of the alternative follower plate.

FIG. 17B is a sectional view of the follower plate taken along line B-B of FIG. 17A.

FIG. 18A is a top plan view of a first adapter.

FIG. 18B is a front view of the first adapter.

FIG. 18C is sectional view of the first adapter taken along line G-G of FIG. 18A.

FIG. 19 is a perspective view of the first adapter.

FIG. 20 is a perspective view of the first adapter with a cartridge installed in the fill position.

FIG. 21A is a perspective view of the first adapter with the cartridge seated on the piston.

FIG. 21B is an enlarged perspective view of Area F of FIG. 21A.

FIG. 22A is a top plan view of a second adapter.

FIG. 22B is a front view of the second adapter.

FIG. 23 is a perspective view of the second adapter.

FIG. 24 is a perspective view of the second adapter with a cartridge installed in the fill position.

FIG. 25A is top plan view of a third adapter.

FIG. 25B is a front view of the third adapter.

FIG. 25C is a sectional view of the third adapter taken along line H-H of FIG. 25A.

FIG. 26 is a perspective view of the third adapter.

FIG. 27A is a perspective view of the third adapter with a cartridge installed.

FIG. 27B is an enlarged view of Area A of FIG. 27A.

FIG. 28A is a perspective view of a fourth adapter.

FIG. 28B is an enlarged view of Area K of FIG. 28A.

FIG. 29A is a front view of an alternative machine press.

FIG. 29B is a sectional view taken along line C-C of FIG. 29A showing the quick release with a thumb screw.

FIG. 30 is a perspective view of the alternative machine press showing the hold down bracket with a thumb screw.

FIG. 31 is a perspective view of a push button slide adjust nut that may used with alternative J-hooks.

### DESCRIPTION OF THE CURRENT EMBODIMENT

The present invention provides fluid transfer apparatus 10 having a machine press 100 that receives a modular follower plate 200 to quickly transfer viscous fluid from bulk storage, such as a pail, to a secondary container, such as a cartridge 80, 81, better store unused pail material and avoid air entrapment during cartridge filling. Costly set up and clean up time associated with prior art equipment is avoided.

Although the present invention is described in connection with a fluid transfer apparatus 10 that transfers fluid from a pail 70 to a cartridge 80, 81 or 82, the present invention may be readily adapted for use in transferring viscous fluid from a wide range of bulk storage containers to a wide range of secondary containers. A cartridge used with this invention may come in different forms and filled from either end. Cartridge material may be clear or translucent plastic preferably to see the fluid material inside. One type may be an injection molded tubular container with open ends. One end may have a larger than the other end. During filling one end receives the fluid material and the other end allows displaced air to escape.

Nordson and Semco are examples of companies that sell injection molded cartridges. These cartridges are manufactured with no draft to function with and receive a floating piston to be installed from the large open end. The opposite end is also open but smaller and often includes a ¼ NPT threaded port for dispensing. Single cartridges are typically domed at the smaller end and use domed pistons. Dual or ‘side by side’ cartridges are typically flat at the smaller end and use flat face pistons. Flat face pistons may include a ‘pre-staged’ air bleed plug in the center to allow air to escape when the piston is first inserted into a filled cartridge. Side by side cartridges are produced to receive reactive materials that cure when mixed as with adhesive or liquid silicone rubber.

A ‘pail’ or ‘cartridge’ for the purpose of this invention is not limited to injection molding or specific material such as plastic. PE, PP, HDPE, LPDE, PETG are all common plastics used for both. However, this invention is not limited to these types of containers. Other manufacturing processes, plastic and non-plastic materials can benefit.

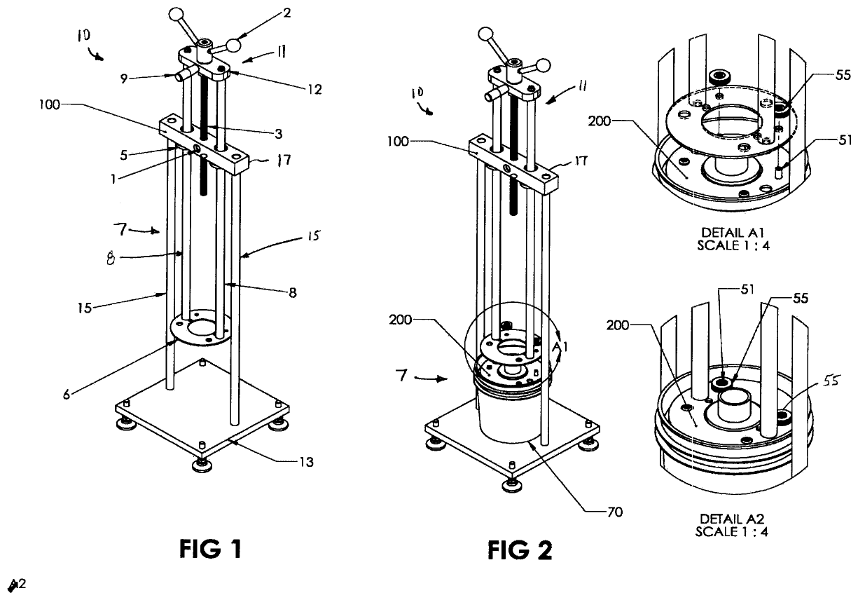

In the illustrated embodiment, the machine press 100 is a mechanically driven vertical press that operates through manual rotation of a threaded shaft with a threaded nut 1 or other threaded structure. As shown in FIG. 1, the machine press 100 of the illustrated embodiment, generally includes a base assembly 7 and a traveling assembly 11. In the illustrated embodiment, the base assembly 7 generally includes a base 13, a pair of uprights 15 and a press member 17. The base 13 provides a surface upon with to place a pail or other bulk storage container. In this embodiment, the base 13 is generally square and is configured to rest upon the ground. As shown, the base 13 may include adjustable-height feet. The uprights 15 are affixed to the base 13 a sufficient distance apart to accommodate a bulk storage container, such as a pail 70, therebetween. Although the illustrated embodiment includes two rod-shaped uprights, the number, size, shape and arrangement of uprights may vary from application to application. The illustrated press member 17 is rigidly affixed to the top ends of the two uprights 15. The press member 17 is configured to movably support the traveling assembly 11. In this embodiment, the press member 17 defines a pair of outer holes configured to receive the upper ends of the uprights 15, a pair of inner holes configured to receive the guide rods 8 of the traveling assembly 11 and a central threaded nut 1 configured to receive the threaded shaft 3 of the traveling assembly 11. In the illustrated embodiment, the inner holes are fitted with a pair of linear guides 5 (or other bushing or bearing assemblies) that facilitate linear movement of the guide rods 8 through the press member 17. The traveling assembly 11 of the illustrated embodiment generally includes a moving plate 12, a pair of guide rods 8, a threaded shaft 3, a crank 2 and an attachment plate 6. In this embodiment, the guide rods 8 are affixed at their upper ends to the moving plate 12 and extend downwardly through the linear guides 5 in the press member 17 and are affixed to the attachment plate 6 at their lower ends. The threaded shaft 3 is journaled within the moving plate 12 and fitted with the crank 2 so that it can be easily rotated through manipulation of the crank 2. The threaded shaft 3 extends downwardly through the press member 17 in threaded engagement with the nut 1 so that rotation of the crank 2 (and consequently the shaft 2) raises or lowers the traveling assembly 11, including the attachment plate 6, relative to the base assembly 7.

In some applications, the fluid transfer apparatus may be configured to straddle rather than directly support the bulk storage container. For example, in alternative embodiments, the bulk storage container may rest directly on the floor or the ground, and the base of the vertical press can be fitted about the bulk storage container. When desired, this may allow the fluid transfer device to be moved into place about the bulk storage container and eliminate any need to lift the bulk storage container and place in on the base of the vertical press. In some applications, the vertical press may hook or clamp to the bulk storage container rather than rest on the ground. For example, in the context of a conventional 55-gallon drum that includes outwardly protruding annular rings, the base of the vertical press may be configured to hook or clamp to one or more of the annular rings to hold on to the drum. This would eliminate the need to lift the 55-gallon drum onto the base of the vertical press.

While not shown, the vertical press may also include a mechanism for holding the bulk storage container down while the vertical press and the modular follower plate are raised. This may be particularly helpful when the bulk storage container is empty and the seal between the modular follower plate the bulk storage container is sufficiently tight that raising the vertical press tends to lift the bulk storage container. The present invention may incorporate essentially any structure capable of holding down the bulk storage container. In one embodiment, the vertical press may include one or more vertically extending J-bolts that are affixed at their lower ends to the base and are capable of being hooked over the upper edge of the bulk storage container to hold the bulk storage container down. For example, each J-bolt may include a threaded lower end that is fitted through a hole in the base and secured from beneath by a nut. The upper end of each J-bolt may be configured to catch on the upper edge or some other feature on the bulk storage container. In typical applications, the apparatus may include one, two or three J-bolts, though a greater number of J-bolts may be included when desired.

Although the present invention is described in the context of mechanical, screw driven vertical press, the fluid transfer apparatus 10 can incorporate essentially any alternative type of press capable of moving the modular follower plate 200 with sufficient force to move the fluid from bulk storage (e.g. pail 70) into a secondary container (e.g. cartridge 80 or 81). For example, the fluid transfer apparatus 10 may, in alternative embodiments, include a manual press, a hydraulic press, a pneumatic press or an alternative type of mechanical press. In some embodiment, it may be desirable to incorporate a motor, pump or other mechanism capable of providing automated movement of the traveling assembly 11.

As noted above, the fluid transfer apparatus 10 of the illustrated embodiment includes a modular follower plate 200 that interfaces with the viscous fluid in the bulk storage container. In the illustrated embodiment, the machine press 100 is configured to quickly attach to and detach from the modular follower plate 200. The machine press 100 of the illustrated embodiment includes an attachment plate 6 with an aperture for receiving a modular follower plate 200 with an integrated cartridge adapter. The attachment plate 6 may include structure to readily attach the modular follower plate 200, such as at least one hole to receive a threaded stud. For example, in the illustrated embodiment, the modular follower plate 200 includes two threaded studs 51 that extend upwardly from the modular follower plate 200. Threaded studs 51 are configured to be fitted through corresponding apertures in the attachment plate 6 and secured by nuts 55 (as described in more detail below). In alternative embodiment, the modular follower plate 200 may be replaced by a follower plate that is integrated into the machine press 100. For example, the follower plate may be affixed directly to the bottom ends of the guide rods 8. In alternative embodiments of this nature, the follower plate may be readily attachable to and removable from the guide rods, but that is not strictly necessary.

The screw press type clamping system makes it possible to easily provide a controlled force and speed of the modular follower plate 200 inside the pail 70. In this embodiment, the attachment plate 6 on the machine press 100 is readily attachable or detachable to a modular follower plate 200 as shown in FIG. 1 and FIG. 2. To facilitate movement of the traveling assembly 11, for example, when the traveling assembly is not under a load, the machine press 100 may include a quick release nut 1 that is seated in the press member 17 in threaded connection to the threaded shaft 3. When the quick release nut 1 is pressed it disengages from the threaded shaft 3, thereby allowing the traveling assembly 11 to be raised and lowered manually without the need to rotate the crank 2. As noted above, the threaded shaft 3 is journaled in a moving plate 12 and rotated by a crank 2. The moving plate 12 is connected to the upper end of at least one guide rod 8. In the illustrated embodiment, the machine press 100 includes two guide rods 8. The guide rods 8 movably pass through linear guides 5 and are connected at their lower end to the attachment plate 6. Although the illustrated embodiment includes two guide rods 8, the number, size, shape and arrangement of guide rods may vary from application to application. The moving plate 12 may also have a handle 9 to help raise or lower the attachment plate 6 when the quick release nut 1 is pressed FIG. 1. In the illustrated embodiment, a pail 57 with modular follower plate 200 may be placed on base 13 of the machine press 200 and aligned for attachment as shown in DETAIL A1 in FIG. 2.

The quick release nut 1 is pressed and the handle 9 is used to lower the attachment plate 6 so that the threaded studs 51 poke through corresponding receiving holes in the attachment plate 6. Nuts, such as thumb nuts 55 can then be used on the threaded studs 51 to attach the modular follower plate 200 to the attachment plate 6 of the machine press 100 as shown in FIG. 2 DETAIL A2. The threaded studs 51 and nuts 55 are only one exemplary mechanism for removably attaching the attachment plate 6 and the modular follower plate 200. In alternative embodiments, the attachment plate 6 and modular follower plate 200 may be joined together by alternative attachment mechanism.

After the machine press 100 is used to transfer material, the modular follower plate 200 can be readily detached and stored by the reverse of the attachment processes described.

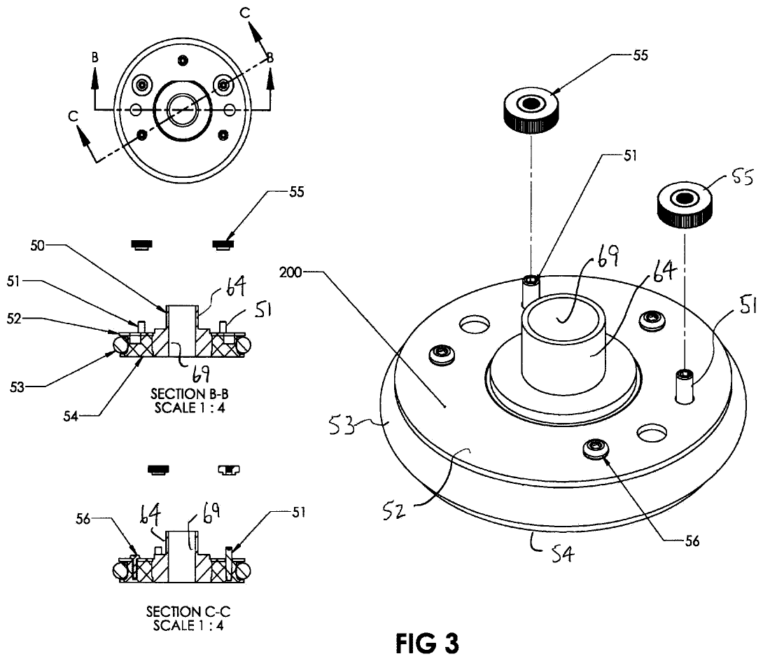

The modular follower plate 200 of the illustrated embodiment is shown is FIG. 3. The modular follower plate 200 may include a bottom plate 54 with an annular recess to accept a compressible seal, a compressible seal 53, a top plate 52, and a cartridge adapter 50. The top plate 52 may be attached to the bottom plate 54 with screws 56 and trap cartridge adapter 50 and compressible seal 53 in between. In one embodiment the modular follower plate has threaded studs 51 protruding from the bottom plate 54 and through the top plate 52. These threaded studs 51 also align with and pass through receiving holes in the attachment plate 6 on the machine press 100. Nuts, such as thumb nuts 55 may be used on the studs to readily attach or detach the modular follower plate. The use of screws 56 is merely one exemplary mechanism for attaching the top plate 52 and the bottom plate 54. In alternative embodiments, the top plate 52 and bottom plate 54 may be attached using other attachment mechanisms, including but not limited to other types of mechanical fasteners. The compressible seal 53 may be foam cord stock cut to a desired length and glued end to end to form a ring shape. In alternative embodiments, the compressible seal 53 may be manufactured using other materials and other manufacturing techniques.

In some embodiments, the modular follower plate 200 is configured for use with material stored in a bulk storage container that has a draft angle in its sidewall. For example, the illustrated embodiment shows a pail 70 that has a slight draft angle meaning that the interior diameter of the pail decreases toward the bottom of the pail. In embodiments in which the bulk storage container varies in diameter, the dimensions of the modular follower plate 200 and the compressible seal 53 may be configured to accommodate the variation in diameter. In general, the modular follower plate 200 and the compressible seal 53 are configured to provide an adequate seal against the interior of the pail 70 throughout the full range of motion of the modular follower plate 200 within the pail. For example, the outer diameter of the modular follower plate 200 may be selected to be slightly smaller than the minimum diameter through which the modular follower plate 200 must pass within the pail 70. This will help to ensure that the modular follower plate 200 can be moved to the bottom of the pail 70, thereby reducing potential waste. Additionally, the compressible seal 53 may be selected to have an outer diameter that is sufficiently greater than the maximum diameter through which the modular follower plate 200 must pass to create an adequate seal even at the maximum diameter of the pail 70.

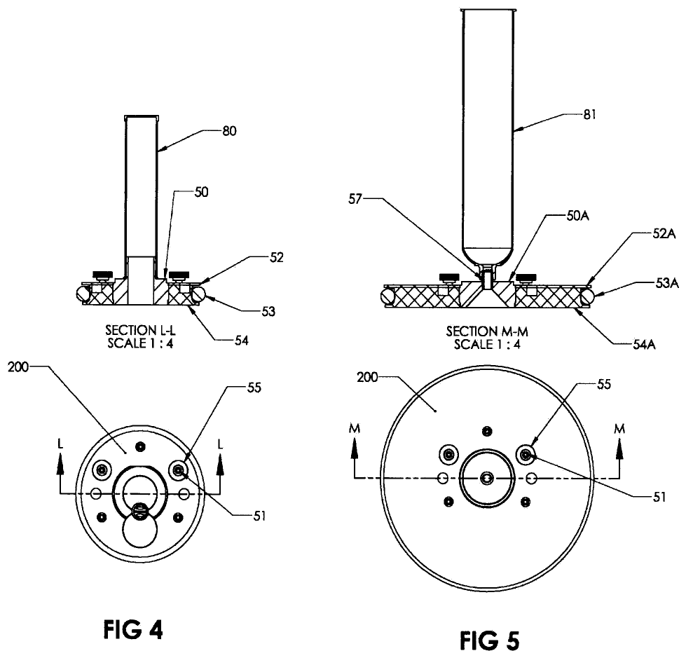

As shown in FIG. 4 and FIG. 5 the modular follower plate 200 may have a different diameter bottom plate 54 and 54A, top plate 52A and compressible seal 53 and 53A in order to fit different size pails while maintaining a common attachment stud 51 location. The modular follower plate 200 may also have a common port in bottom plate 54 to accept different cartridge adapter 50 designs. A cartridge adapter 50 may attach to the large bore diameter end of a cartridge as shown in FIG. 4 or it may attach to the smaller threaded end of a cartridge 81 as shown in FIG. 5. Cartridge adapter 50 selection depends on material viscosity. Lower viscosity materials are better suited for filling cartridges from the smaller threaded end. Different cartridge adapters 50 can be used within the modular follower plate 200 to fit many different cartridge bore diameters or threaded ends.

In some embodiments, the modular follower plate may be provided without a circumferential seal when a seal is not needed to provide acceptable operation of the fluid transfer apparatus. For example, in applications intended for use with straight-wall containers (or containers with sufficiently straight walls), the modular follower plate may have a tight enough fit within the container to allow use without the need for a circumferential seal between the modular follower plate and the inner surface of the bulk container. To illustrate, this approach may be suitable for use with viscous material stored in a straight-walled 55-gallon drum. In some applications, the viscous fluid may be stored in a liner (e.g. a plastic liner) that helps to provide an adequate seal with the rigid outer edge of the modular follower plate to allow for elimination of a separate circumferential seal.

It should be understood that the illustrated modular follower plate 200 is merely exemplary and that the design and configuration of the modular follower plate may vary from application to application. For example, the size and shape of the modular follower plate may vary from application to application to accommodate different sizes and shaped bulk storage containers. Although the modular follower plate 200 of the illustrated embodiment is described as a multipart assembly, the modular follower plate may alternative be formed with two or more of its parts integrated together. For example, in some applications, the top plate 52, bottom plate 54 and cartridge adapter 50 may be integrally formed, such as through machining or molding operations.

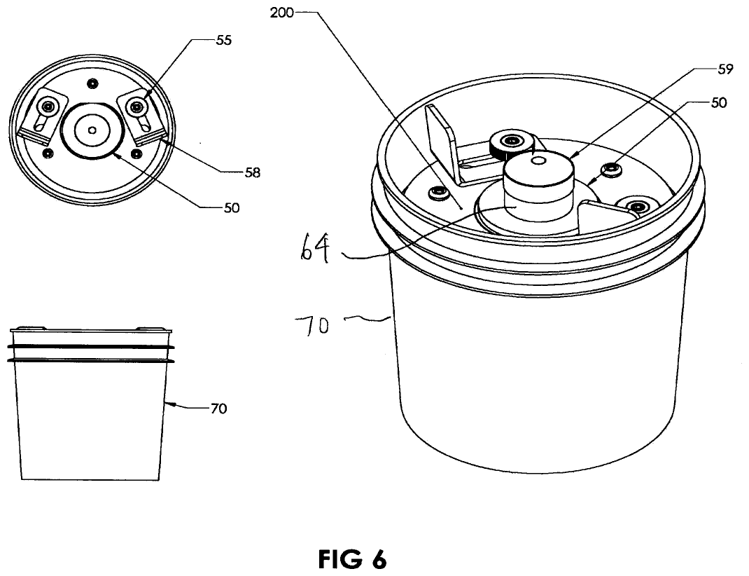

After a modular follower plate 200 is used to fill a cartridge, it can be detached and remain stored in the material pail as shown in FIG. 6. Brackets 58 may be attached using the thumb nuts 55 and positioned to help stabilize the modular follower plate 200 inside the pail 70. A cap 59 may be used to cover the end of the cartridge adapter 50. This preparation helps to prevent the modular follower plate 200 from tilting and sinking into the viscous material. Storing the modular follower plate inside the pail eliminates the need for cleaning in between uses and also prevents air coming into contact with the viscous fluid. The later may improve the shelf life of the material if it is the type of material that reacts with air.

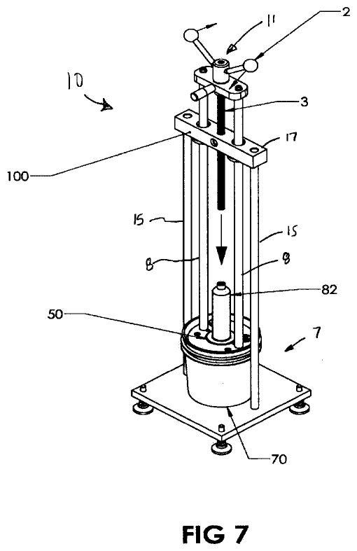

After a pail 70 with a modular follower plate 200 is inserted into the machine press 100 and attached as shown in DETAIL A2 of FIG. 2, a cartridge 82 can be placed onto the cartridge adapter 50 in the modular follower plate 200 as shown in FIG. 7. The crank 2 is rotated which in turn moves the threaded shaft 3 downward pushing the modular follower plate 200 into the pail. This motion forces the viscous material to flow up through the central through-opening 69 in the cartridge adapter 50, 50A and enter the lower end of the cartridge 82 while air is allowed to escape at the upper end. Once the cartridge 82 is filled to the top it may be capped at the top (not shown), removed and flipped in order to install the cartridge piston (not shown) at the other end. Sliding the cartridge 82 sideways off the face of the cartridge adapter 50 can help scrap off viscous material before flipping over the cartridge for piston installation. Squeezing the side of the cartridge can help create a slightly non-circular bore that helps air escape during piston installation.

In embodiments of the present invention that are intended for use in filling cartridges from the large bore diameter end, the cartridge adapter may include a cartridge seat 64 that generally corresponds with the volume of the piston that will be fitted into the filled cartridge. Once the filled cartridge is removed from the cartridge seat, this will leave a void in the interior of the cartridge at the large bore diameter end of sufficient size to receive the piston.

Another feature that can be added to the machine press 100 is a cartridge holder 300 to aid in piston installation as shown in FIG. 8. The cartridge holder 300 may generally consist of a bent plate 60, pivot handle 65, angle plate 61 and linear bearing 62. The bent plate 60 is configured to removably receive a cartridge to be filled by the apparatus 10. Although referred to as a “bent” plate, the bent plate 60 need not actually be formed by bending, and may be essentially any receiver plate capable of receiving a cartridge. The angle plate 61 is configured to secure the cartridge to the bent plate 60. Although referred to as an “angle” plate, the angle plate 61 need not include an angle, and may be essentially any securing member capable of securing a cartridge to the bent plate 60. The angle plate 61 may have a cartridge knob 68, locator knob 66 and slot guide screw 67 as shown in Detail N. A cartridge may be inserted into the cartridge location noted. The angle plate 61 can be positioned against cartridge and tightened in place with knob 66. Cartridge knob 68 may also be tightened in order to flex the cartridge into a slightly non-circular shape. A non-circular shape helps air escape when a piston is inserted at the open end of a filled cartridge. The lower slot noted allows the angle plate 61 to adjust and accept different cartridge diameters. The upper slots noted allows centering of the cartridge holder 300 when installed to the machine press 100. When centered, knobs 63 may be tightened to hold the bent bracket 60 in place. As can be seen, the illustrated embodiment includes slots that facilitate adjustment of the position of the bent plate 60 and the angle plate 61. This adjustment mechanism is merely exemplary and the cartridge holder 300 incorporate alternative adjustment mechanisms for adjusting the position of the bent plate 60 and the angle plate 61. In those applications in which the cartridge holder 300 in configured for use with a single size of cartridges, the bent plate 60 may be implemented without an adjustment mechanism.

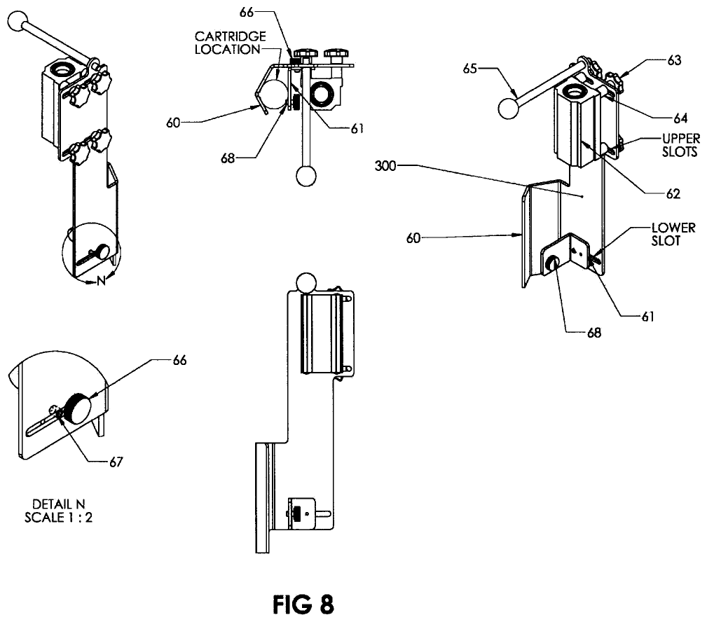

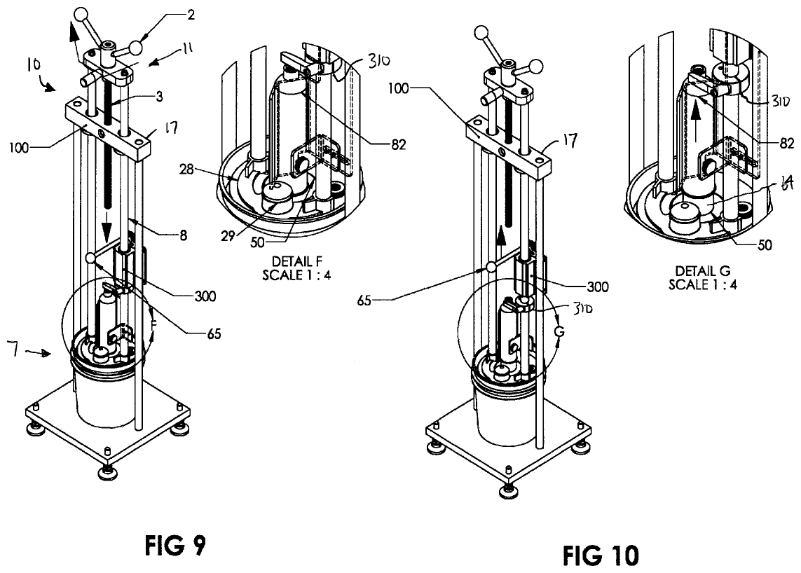

Cartridge holder 300 may be installed onto the guide rod 8 of the machine press 100 as shown in FIG. 9. In alternative embodiments, the cartridge holder 300 may be mounted additionally or alternatively to other parts of the machine press 100, such as the other guide rod 8, one or both of the uprights 15, or the attachment plate 6. In some applications, the cartridge holder 300 may be mounted to structure other than the machine press 100. In the illustrated embodiment, a piston nest bracket 28 is also attached to guide rod 8 of machine press 100. A piston 29 may be placed into a recess of piston nest bracket 28 and a cartridge 82 installed within the cartridge holder 300 as previously described and shown in DETAIL F. The pivot handle 65 can be used to position the cartridge holder 300 so the cartridge 82 is fitted over the cartridge seat 69 of the cartridge adapter 50. As shown in FIG. 9, the crank 2 is rotated which in turn moves the threaded shaft 3 downward pushing the modular follower plate 200 progressively farther down into the pail. This motion forces the viscous material to pass up through the through-hole in the cartridge adapter 50 and enter the lower end of the cartridge 82 while air is allowed to escape through the opening at the upper end of the cartridge 82.

After the cartridge is filled the pivot handle 65 is lifted to raise cartridge holder 300 high enough so that the bottom of the cartridge 82 clears the cartridge adapter 50 as shown in FIG. 10 and DETAIL G. In some implementations, the cartridge 82 is raised just high enough to clear the upper end of the cartridge adapter 50. This improves the ability of the system to scrape away stringing or excess fluid when the cartridge 82 is moved transversely over the upper face of the cartridge adapter 50.

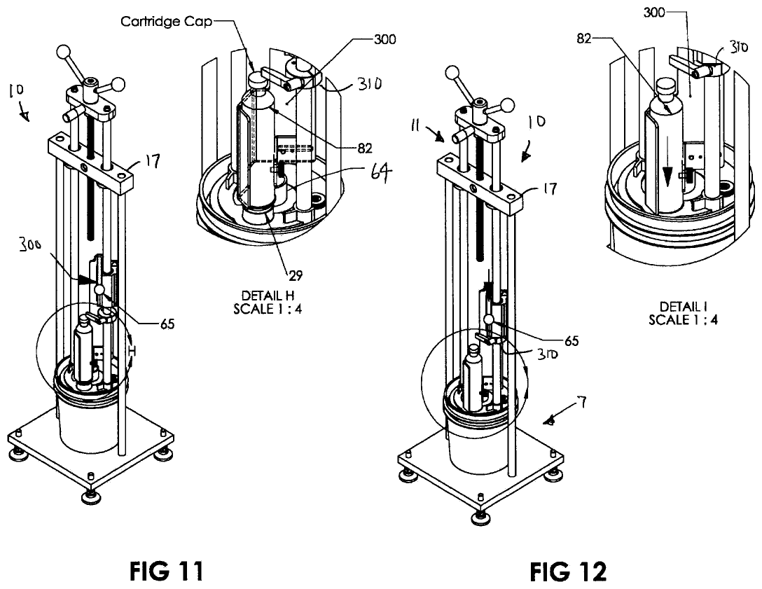

As shown in FIG. 11, a cartridge cap is installed over the cartridge seat 64 to seal the through-hole 69 and the pivot handle 65 is rotated to position the cartridge holder 300 and cartridge 82 directly over the piston 29. During this rotation process any viscous material that is stretched inside the cartridge is separated and scraped off the top face of the cartridge adapter 50. This scrapping action helps to eliminate mess during cartridge 82 and before piston installation.

As shown in FIG. 12, the pivot handle and cartridge holder 300 is pushed down. This pushes the cartridge 82 over the piston 29 to install it. As previously described the knob 68 provides a slightly non-circular shape to the cartridge bore to help air escape during piston installation. In some applications, knob 68 is tightened after the cartridge 82 has been filled, but before it is pushed down onto the piston. This may help to prevent issue that may result from cartridge deformation during filling.

When desired, the fluid transfer apparatus may include a mechanism for holding the cartridge down on the cartridge seat while it is being filled. In some applications, the tightness of the fit between the cartridge and the cartridge seat will be sufficient to hold down the cartridge during filling. In such applications, no further hold-down mechanism may be provided. In some applications, the cartridge may be held down manually. For example, the operator may apply manual pressure to the cartridge to hold it down during filling. In applications that include a cartridge holder 300, the cartridge holder 300 may be used to hold down the cartridge during filling. For example, a shaft collar (not shown) may be temporarily clamped to the guide rod 8 just above the linear bearing 62 after the cartridge has been fully lowered onto the cartridge seat. The clamped shaft collar will prevent the cartridge holder 300 from being raised, thereby holding the cartridge down onto the cartridge seat. The shaft collar can be released after filling to allow the cartridge holder 300 to be raised high enough to release from the cartridge seat. Although a shaft collar configured to hold down the cartridge holder is not shown, a similar shaft collar 310 is shown in FIG. 9-12. Shaft collar 310 is used to set a limit on the downward travel of the cartridge holder 300. While not shown, an additional shaft collar may be added to the guide rod 98 above the linear bearing to provide a limit on the upward movement of the linear bearing 62 to ensure that the bottom end of the cartridge 82 just clears the top edge of the cartridge seat 64 when the cartridge 82 is swung radially from a position above the cartridge seat 64 to a position above the piston holder. If desired, a pair of shaft collars may be installed above the linear bearing 62 with the lower shaft collar being movable during operation and the upper shaft collar setting an upward limit on the movement of the lower shaft collar. More specifically, the lower shaft collar may be lowered to hold the cartridge holder 300 down in the fully seated position and may be raised up against the upper shaft collar to set the upward limit on movement of the cartridge holder during radial movement of the cartridge holder 300, which is used to scrape the bottom of the cartridge 82 as discussed above.

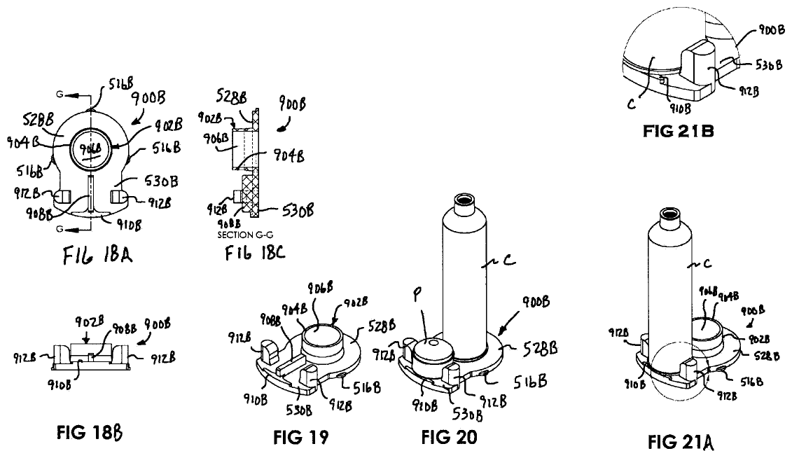

An alternative embodiment of the present invention is shown in FIGS. 13A-28B. In this embodiment, the fluid transfer apparatus 410 includes machine press 500 that receives a follower plate 600 configured to interchangeably receive one a plurality of different adapters 900A-E that facilitate filling of a wide range of receptacle, including various cartridges, pails and other containers. Machine press 500 is similar to machine press 100 including a base assembly 407 and a traveling assembly 11. In the illustrated embodiment, the base assembly 407 generally includes a base 413, a pair of uprights 415 and a press member 417. The base 413 includes adjustable-height feet. The base assembly 407 further includes an elevated platform 404 that provides a surface upon with to place a pail or other bulk storage container. The platform 404 defines a pair of elongated slots 90 configured to receive one or more J-hooks 92 that can selectively be used to secure a pail or other container to the platform 404. In this embodiment, a removable fastener 94 is slidably fitted over the straight end of each J-hook 92. The illustrated fastener 94 includes a thumb screw 96 that is capable of securing the fastener 94 in the desired position along the length of the J-hook 92. In use, the hooked ends of the J-hooks 92 can be fitted over the lip of the pail or other container and the straight end can be fitted through the corresponding slot 90 and securely fastened by the fastener 94. When not in use, the J-hooks 92 may be temporarily stored in a bracket 98 secured to one of the uprights 415.

In an alternative embodiment, the ends of the J-hooks 92 may be threaded and the removable fastener 94/thumb screw 96 may be replaced by one or more push-button slide-adjust nut 430 of the type shown in FIG. 31. For example, in the embodiment shown in FIG. 30, each J-hook 92 may be fitted with two push-button slide-adjust nuts 430. Suitable push-button slide-adjust nuts are available from McMaster-Carr at, for example, mcmaster.com.

In this embodiment, the machine press 500 includes two spaced-apart uprights 415 formed from rectangular tube-shaped extrusions. The number, size, shape and arrangement of uprights may vary from application to application.

As with machine press 100, the press member 417 of this embodiment is rigidly affixed to the top ends of the two uprights 415. The press member 417 is configured to movably support the traveling assembly 411. In this embodiment, the press member 417 is affixed to the upper ends of the uprights 415. The press member 417 defines a pair of inner holes configured to receive the guide rods 408 of the traveling assembly 411 and a central threaded nut 401 configured to receive the threaded shaft 403 of the traveling assembly 411. In the illustrated embodiment, the inner holes are fitted with a pair of linear guides 405 (or other bushing or bearing assemblies) that facilitate linear movement of the guide rods 408 through the press member 417. Similar to traveling assembly 11, the traveling assembly 411 of this alternative embodiment generally includes a moving plate 412, a pair of guide rods 408, a threaded shaft 403, a crank 402 and an attachment plate 406. In this embodiment, the guide rods 408 are affixed at their upper ends to the moving plate 412 and extend downwardly through the linear guides 405 in the press member 417 and are affixed to the attachment plate 406 at their lower ends. The threaded shaft 403 is journaled within the moving plate 412 and fitted with the crank 402. The threaded shaft 403 extends downwardly through the press member 417 in threaded engagement with the nut 401 so that rotation of the crank 402 raises or lowers the traveling assembly 411. As with machine press 100, nut 401 is a quick release nut that is capable of being disengaged from the thread shaft 403. When desired, the quick release nut 401 can be disengage and the traveling assembly 411 can be moved up or down without the need to operate the crank 402.

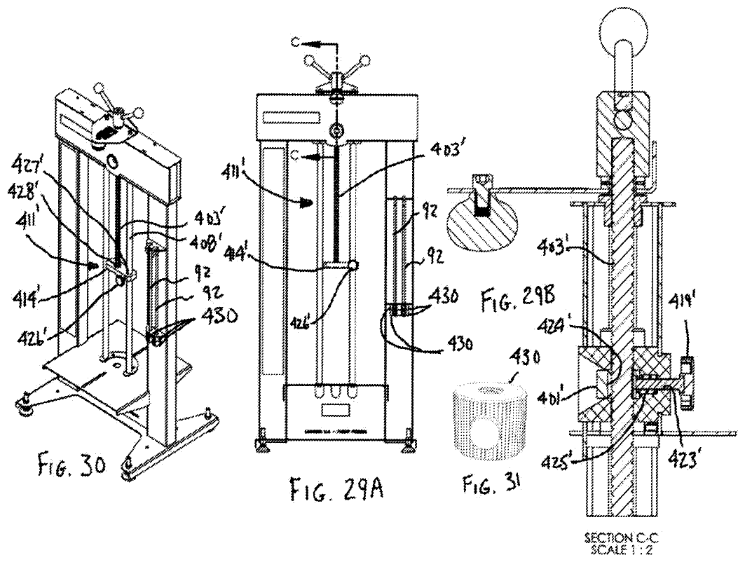

In an alternative embodiment shown in FIGS. 29A-B, the quick release nut may be provided with a thumb screw that can be used to prevent inadvertent disengagement of the quick release nut from threaded shaft 403′. In this embodiment, the quick release nut 401′ includes an opening 424′ that is fitted about the threaded shaft 403′. One side of the quick release nut 401′ is threaded and the opposite is non-threaded. When the threaded side of the opening 424′ is engaged with the threaded shaft 403′, rotation of the threaded shaft 403′ is required to move the traveling assembly 411′. To release the quick release nut 401′ to allow movement of the traveling assembly 411′ without rotation of the threaded shaft 403′, the quick release nut 401′ is move in a direction perpendicular to the axis of the threaded shaft 403′ until the thread side of the opening 424′ is disengaged from the threaded shaft 403′. To help prevent unwanted disengagement of the quick release nut 401′ from the threaded shaft 403′, a thumb screw 419′ may be threadedly fitted into a threaded hole 423′ defined in the nut housing 421′. The thumb screw 419′ and threaded hole 423′ are configured so that the thumb screw 419′ can be threaded inwardly into contact with the quick release nut 401′ to hold the threaded side of the opening 424′ in engagement with the threaded shaft 403′ or threaded outwardly to provide room for the quick release nut 401′ to be moved into a position in which the threaded side of the opening 424′ is disengaged from the threaded shaft 403′. In this embodiment, the thumb screw 419′ is configured to pass through the central opening in the quick release nut spring 425′, which provide a resilient bias to urge the threaded side of the opening 424′ into engagement with the threaded shaft 403′.

In this embodiment, the attachment plate 406 is affixed to the bottom of the guide rods 408 and is generally U-shaped to accommodate a range of interchangeable adapters 900A-E, as discussed in more detail below.

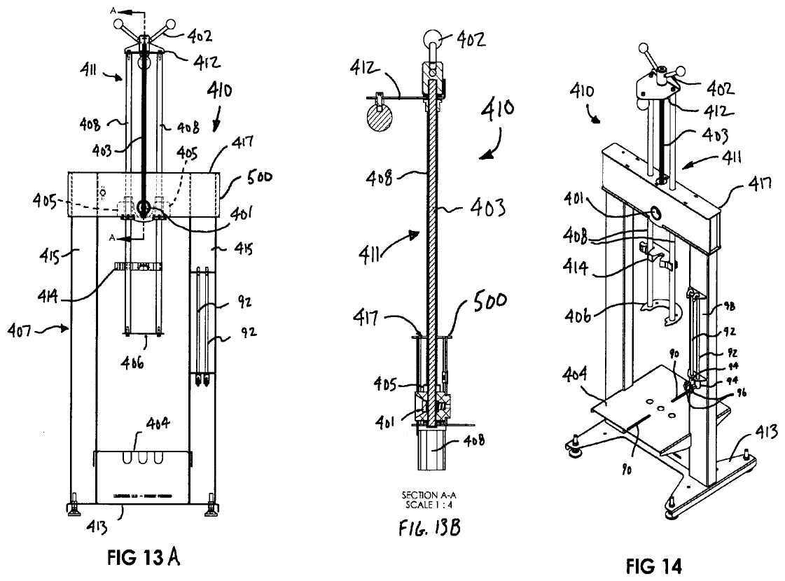

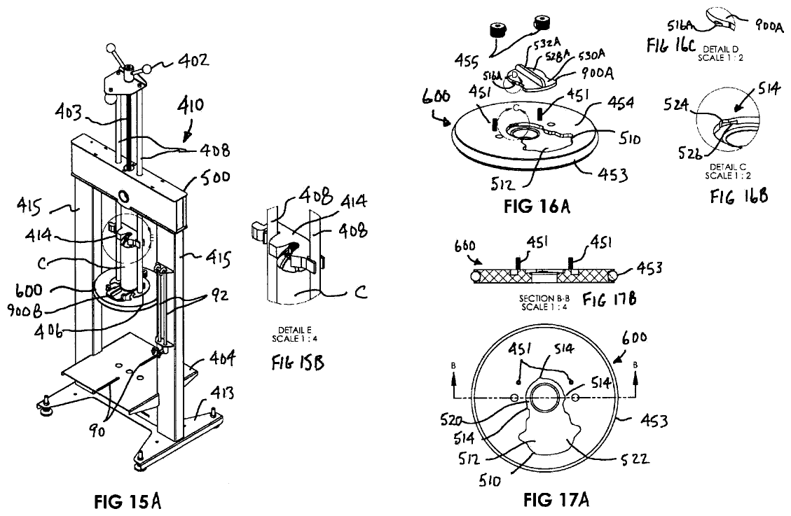

In this embodiment, the traveling assembly 411 also includes a cartridge hold-down 414 that is removable fitted onto the guide rods 408 (See FIG. 15B). In this embodiment, the hold-down 414 is frictionally fitted onto the guide rods 408, and can be positioned as needed to engage and hold down the cartridge or other container during filling. The tightness of the fit between the hold-down 414 and the guide rods 408 is configured to be sufficient to withstand the forces encountered during filling. In the illustrated embodiment, the hold-down 414 is installed by fitting longitudinally opening tabs at one end of the hold-down onto a first guide rod 408 and then pivoting the opposite end of the hold-down 414 until a laterally opening set of tabs snap fit into place about the other guide rod 408. This configuration of the hold-down 414 is merely exemplary and the hold-down 414 may be secured to the guide rods 408 using alternative structure, such as one or more thumb screws or clamping arrangements. In some applications, no hold-down may be provided.

FIG. 30 shows an alternative cartridge hold-down 414′. In this embodiment, the hold-down 414′ is fitted over one of the guide rods 408′ and includes a thumb screw 426′ that can be selectively tightened and loosened to secure and release the hold-down 414′ relative to the guide rod 408′. In this embodiment, the cartridge hold-down 414′ defines a guide-rod opening 427′ that is receives one of the guide rods 408′. The thumb screw 426′ is threadedly fitted into a threaded hole defined in the hold-down 414′ adjacent to the guide rod opening 427′. The threaded hole and thumb screw 426′ are arranged so that the thumb screw 426′ can be threaded inwardly to cause the inner end of the thumb screw 426′ to engage the guide rod 408′ (to lock the hold-down 414′ in place) or the thumb screw 426′ can be threaded outwardly to cause the inner end of the thumb screw 426′ to disengage from the guide rod 408′ (to allow movement of the hold-down 414′ allow the guide rod 408′). In this embodiment, the hold-down 414′ is fitted over one of the two guide rods. In alternative embodiments, the hold-down may include a second guide rod opening and the hold-down can be fitted over both guide rods. The hold-down 414′ may be configured to fit snugly over the guide rods 408′ so that it will generally maintain its position on the guide rod or guide rods until moved. In the illustrated embodiment, the hold-down 414′ includes a shaft opening 428′ that can loosely receive the threaded shaft 403′ if the hold-down 414′ is moved far enough upwardly.

As noted above in connection with fluid transfer apparatus 10, the fluid transfer apparatus 410 of this alternative embodiment can alternatively incorporate essentially any alternative type of manual or automated press capable of moving the modular follower plate with sufficient force to move the fluid from bulk storage (e.g. pail) into a secondary container (e.g. cartridge).

Referring now to FIGS. 15-17B, the fluid transfer apparatus 410 includes a follower plate 600 that interfaces with the viscous fluid in the bulk storage container in essentially the same way as the follower plate 200 of fluid transfer apparatus 10. In summary, the follower plate 600 includes two threaded studs 451 that extend upwardly from the modular follower plate 600. Threaded studs 451 are configured to be fitted through corresponding apertures in the attachment plate 406 and secured by nuts 455. The illustrated follower plate 600 attachment is merely exemplary. In alternative embodiments, the fluid transfer apparatus may include essentially any attachment that allows the follower plate to be attached and detached from the press and stored inside the pail. Using any number or type of attachment including but not limited to threaded fasteners used with or without tools, twist lock fasteners, twist button fasteners, turn latches, toggle clamps, releasable magnetic mounts are some examples of the different type of attachment methods that could be used within the scope of the invention. In alternative embodiment, the follower plate 600 may be replaced by a follower plate that is integrated into the machine press, for example, by direct attachment to the guide rods 408.

The follower plate 600 of FIGS. 15-17B includes a one-piece body 454 with an annular recess to accept a compressible seal 453. In alternative embodiments, the follower plate 600 may be an assembly of various components. The follower plate 600 may be manufactured from a hard and durable plastic (such as HDPE plastic) or other materials using generally conventional techniques and apparatus. In this embodiment, the body 454 is formed with a receiver 510 configured to receive any one of a number of interchangeable adapters 900A-E. In the illustrated embodiment, the follower plate 600 has threaded studs 451 protruding upwardly from the body 454. The threaded studs 451 also align with and pass through receiving holes in the attachment plate 406. Nuts, such as thumb nuts 455, may be used on the studs to readily attach or detach the modular follower plate. The thumb-nuts 455 may be conventional push-button nuts that can be quickly seated and removed. The compressible seal 453 may be foam cord stock cut to a desired length and glued end to end to form a ring shape. In alternative embodiments, the compressible seal 453 may be manufactured using other materials and other manufacturing techniques.

As noted above, the follower plate 600 includes a receiver 510 configured to removably receive any one of a number of interchangeable adapters 900A-E. For example, in the illustrated embodiment, the receiver 510 is capable of receiving a cap adapter 900A (See FIG. 16A), a small cartridge adapter 900B (See FIG. 20), a large cartridge adapter 900C (See FIG. 24), a threaded cartridge adapter 900D (See FIG. 27A) and a spout adapter 900E (See FIG. 28). These are exemplary adapters and additional/alternative adapters may be provided to facilitate filling of a wide range of alternative containers. The follower plate 600 and adapters 900A-E may be configured to interconnect in essentially any way. However, in the illustrated embodiment, the follower plate 600 and adapters 900A-E are interconnected by an arrangement of lugs and slots that are engaged and disengaged through rotating motion of the adapter 900A-E relative to the follower plate 600. With this configuration, adapters 900A-E can be easily removed and replaced without the need for tools or fasteners. In this embodiment, the receiver 510 is formed by a recess 512 defined in the top surface of the follower plate 600. The recess 512 includes a head seat 520 and a tail seat 522. The recess 512 includes a plurality of slots 514 disposed about the head seat 520. The slots 514 are configured to interact with ears 516 extending from each adapter 900A-E. In the illustrated embodiment, the receiver 510 includes three slots 514 arranged in a radial pattern about the head seat 520. Each slots 514 includes a throughway 524 and an undercut 526 (See FIGS. 16A-16C and 17A).

An adapter 900A-E is secured to the follower plate 600 by fitting it down into the recess 512 and rotating a prescribed distance. More specifically, the adapter 900A-E is positioned above the receiver 510 with the ears 516 in vertical alignment with the throughways 524. The adapter 900A-E is then pushed down into the receiver 510 with the ears 516 traveling down the throughways 524 until the adapter 900A-E bottoms out in the receiver 510. At this point, the ears 516 will have traveled down into alignment with the slots 514, which are undercut extensions of the throughways 524 (See FIG. 16B). The adapter 900A-E is then pivoted relative to the receiver 510 to move the ears 516 into the slots 514 and secure the adapter 900A-E in the fully seated position. One or more of the slots 514 may be provided with small protrusions (not shown) that help to snap-lock the adapter 900A-E in place through an interference fit. In this embodiment, each adapter 900A-E generally includes a head portion 528 and a tail portion 530. The head portion 528 is generally circular and is configured to be seated and rotated within the generally circular head seat 520. As shown, the head portion 528 has a diameter that is slightly smaller than the diameter of the head seat 520. The ears 516 extend radially outward from the head portion 528. In the illustrated embodiment, the head portion 528 includes three radially symmetric ears, but the number, size, shape and arrangement of ears may vary from application to application as desired. The tail portion 530 is configured to be seated within the tail seat 522 of the receiver 510. To interlock and release the adapter 900A-E from the receiver 510, the tail portion 530 is pivoted within the tail seat 522.

FIG. 16A is an exploded view of the follower plate 600 and the cap adapter 900A. The cap adapter 900A is intended to close the follower plate 600 when not in use. The cap adapter 900A includes a head portion 528A with ears 516A, a tail portion 530A and upright rib 532A that can be gripped to facilitate pivotal movement of the cap adapter 900A within the receiver 510.

FIGS. 18A-21-B illustrate a cartridge adapter 900B configured to bottom fill a range of cartridges that have a corresponding bottom opening. For example, cartridge adapter 900B is suitable for filling one common line of cartridges that is available in 2.5 ounce through 12 ounce sizes. The cartridge adapter 900B includes a head portion 528B with an upwardly extending cartridge port 902B that includes a circumferential wall 904B surrounding a central opening 906B. configured to receive the open bottom end of a cartridge C (See FIG. 20). In this embodiment, the bottom portion of the wall 904B may be angled to provide a tight fit with the open end of the cartridge C. The tail portion 530B of the cartridge adapter 900B includes a piston nest 908B that is configured to receive a piston P for closing the bottom end of the cartridge C after it has been filled. The piston nest 908B is sized and shaped to provide a relatively firm friction fit with the piston P. In this embodiment, a small ledge 910B is disposed at one end of the piston nest 908B. The ledge 910B is configured so that a piston P pushed fully down onto the piston nest 908B will be slightly tilted with respect to the vertical axis. This helps to facilitate insertion of the piston P into the cartridge C. The tail portion 530B of the cartridge adapter 900B also includes a pair of lugs 912B that squeeze the bottom end of the cartridge C as the cartridge C is pushed down onto the piston P. The lugs 912B squeeze the bottom end of the cartridge C from opposite sides causing the bottom end of the cartridge C to deform into a somewhat oval shape, which creates a path for air to release from the interior of the cartridge C as the cartridge C is pushed down onto the piston P. The bottom portion of the inner face of one or both lugs 912B may be inclined to increase the deformation of the cartridge C as the cartridge C is pushed farther down.

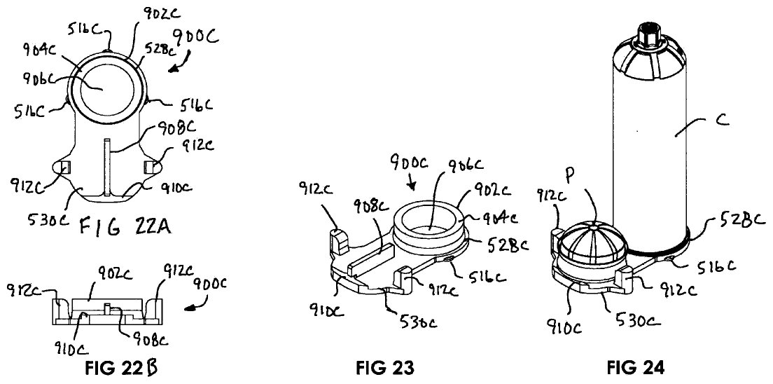

FIGS. 22A-24 illustrate a second cartridge adapter 900C that is similar to cartridge adapter 900B, except that it is configured to fill larger cartridges (i.e. cartridges with a larger open bottom end). For example, the second cartridge adapter 900C is intended for use in filling a conventional line of cartridges that are available in 20 ounce through 32 ounce sizes. Referring now to FIGS. 22A-23, the second cartridge adapter 900C includes a head portion 528C that is generally identical to head portion 528B, except that the cartridge port 902C is substantially larger, including a substantially larger central opening 906C and a substantially larger circumferential wall 906B. The tail portion 530C of cartridge adapter 900C is generally identical to tail portion 530B, except that it is scaled up to accommodate a larger cartridge C and a larger piston P.

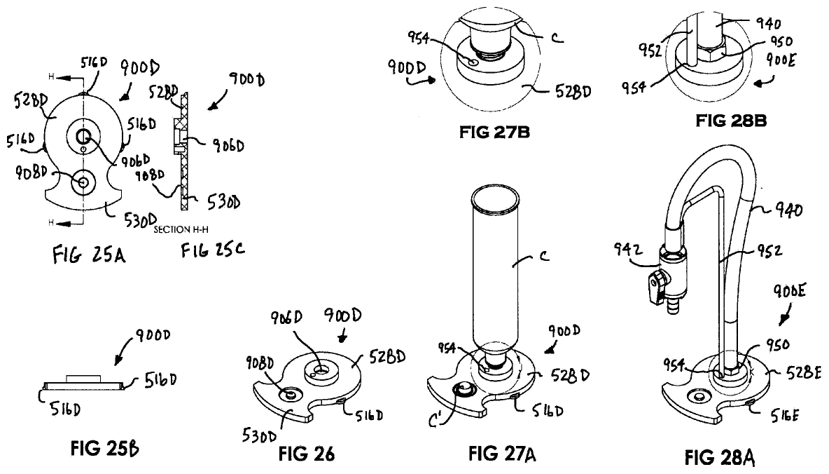

FIGS. 25A-27B illustrate an adapter 900D that is used to fill cartridges through the smaller, threaded end, which is most commonly a ¼ inch female NPT pipe thread. This ‘NPT’ adapter 900D may be best suited for use with lower viscosity fluids. Referring now to FIGS. 25A-26, the adapter 900D generally includes a head portion 528D and a tail portion 530D. The head portion 528D includes a central opening 906D that is internally threaded to receive a male-to-male coupler (not shown). One end of the coupler is configured to threadedly seat in the central opening 906D and the other end of the coupler is configured to threadedly seat in the threaded NPT end of the cartridge C. In the illustrated embodiment, the two ends have the same diameter, but they may vary in alternative applications. The tail portion 530D includes a small cap seat 908D that is sized and shaped to retain a cap C′ that can be used to close the threaded end of the cartridge C once it has been filled.

FIG. 28 illustrates another alternative adapter. In this embodiment, the adapter 900E is provided with a hose 940 and a spigot 942 that can be used to fill a wide range of containers (not shown). In this embodiment, the spigot adapter 900E is formed from the NPT adapter 900D. More specifically, a hose adapter 950 is threadedly seated in the central opening 906D. The hose adapter 950 includes an inner end that is externally threaded to engage the internally threaded central opening 906D and an outer end that is configured to interconnect with the hose 940. For example, the second end may include a barbed tube that is tightly fitted into the open end of the hose 940. The spigot 942 includes a valve that can be opened and closed as desired for filling and storage. In this embodiment, the spigot adapter 900E includes a support wire 952 with a first end fitted into a blind hole 954 in the adapter 900E and second end connected to the spigot or to the hose near the spigot. The support wire 952 helps to provide a stable and rigid support for the spigot. The support wire is merely exemplary and the spigot may be unsupported or be supported using other structures.

The invention described above and shown in the drawings allows viscous material to be transferred from a pail or other form of bulk storage to a secondary container, such as a cartridge for mixing while addressing the issues with waste, clean up, mess, air entrapment and storage of material in the pail in between uses.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A fluid transfer apparatus for moving material from a bulk storage container to a secondary container comprising:
a vertical press having an attachment plate, the vertical press configured to selectively raise or lower the attachment plate;
a modular follower plate removably affixed to the attachment plate to move with the attachment plate as the attachment plate is selectively raised or lowered by the vertical press, the modular follower plate including a secondary container seat configured to receive a secondary container into which a fluid is to be transferred, the modular follower plate defining a through-hole through which a fluid contained in a bulk storage container may pass into a secondary container seated on the secondary container seat as the modular follower plate is moved downwardly into a bulk storage container by the vertical press.

2.-7. (canceled)

8. The fluid transfer apparatus of claim 1,
wherein the modular follower plate includes a circumferential seal configured to engage an interior surface of a bulk storage container;
wherein the traveling assembly includes:
a threaded shaft threadedly engaged with the press member; and
at least one guide rod slidably engaged with the press member;
wherein the traveling assembly includes two guide rods slidably engaged with the press member, the two guide rods being disposed on opposite sides of the threaded shaft;
wherein the base assembly includes two uprights extending upwardly from the base, the two uprights being affixed toward opposite ends of the press member;
wherein the base assembly includes a nut fitted within the press member, the nut being threadedly engaged with the threaded shaft; and
wherein the nut is further defined as a quick release nut.

9. The fluid transfer apparatus of claim 1 wherein the modular follower plate includes a top plate and a bottom plate that are closed about a cartridge adapter, the cartridge adapter including the cartridge seat and defining the through-hole.

10. The fluid transfer apparatus of claim 1 wherein the secondary container seat is configured to occupy a volume within a secondary container disposed on the secondary container seat that is about equal to a volume of a piston to be inserted into a secondary container.

11. (canceled)

12. The fluid transfer apparatus of claim 9 wherein the top plate and the bottom plate cooperatively define a circumferential channel, the circumferential seal being seated within the circumferential channel.

13. The fluid transfer apparatus of claim 2,
wherein the modular follower plate includes a circumferential seal configured to engage an interior surface of a bulk storage container;
wherein the modular follower plate is configured to be fitted into a bulk storage container having a fluid containing internal portion with an inner diameter that varies between a maximum inner diameter and a minimum inner diameter;
wherein the modular follower plate includes a top plate and a bottom plate that are closed about a cartridge adapter, the top plate and the bottom plate each have an outer diameter selected to be just small enough to fit within an inner diameter of a bulk container when the modular follower plate is disposed in alignment with a minimum inner diameter portion of a fluid containing portion; and
wherein the circumferential seal has an outer diameter that is sufficiently greater than a maximum diameter inner diameter of a bulk storage container to create an effective seal when the modular follower plate is disposed in alignment with a maximum inner diameter of a bulk storage container.

14. The fluid transfer apparatus of claim 1 further including:
a secondary container holder movably affixed to the vertical press, the secondary container holder having a receiver plate configured to receive a secondary container and a securing member configured to secure a secondary container to the receiver plate; and
a piston holder configured to receive a piston; and
wherein the secondary container holder is selectively movable between a first position in which a secondary container is fitted onto the secondary container seat and a second position in which a secondary container is fitted onto a piston seated on the piston holder.

15. The fluid transfer apparatus of claim 14 wherein the secondary container holder includes a linear bearing, the linear bearing being movably fitted to the vertical press, the linear bearing allow selective vertical motion of the receiver plate relative to the vertical press, whereby a secondary container carried by the secondary container holder can selectively be moved vertically into and out of engagement with the secondary container seat and the piston holder.

16. The fluid transfer apparatus of claim 14 wherein the linear bearing allows selective radial motion of the receiver plate relative to the vertical press, whereby a secondary container carried by the secondary container holder can be selectively moved from vertical alignment with the secondary container seat to vertical alignment with the piston holder.

17. The fluid transfer apparatus of claim 14 wherein the secondary container holder includes a deformation element confirmed to deform the end of a secondary container to allow air to escape when a secondary container is moved down onto a piston.

18. The fluid transfer apparatus of claim 1 wherein the secondary container is a cartridge.

19. The fluid transfer apparatus of claim 1 wherein the bulk storage container is a pail.

20. A method of operating a fluid transfer apparatus in accordance with claim 1 to transfer fluid from a bulk storage container to a secondary container.

21. A fluid transfer apparatus for moving material from a bulk storage container to a secondary container comprising:
a press having an attachment plate, the press configured to selectively move the attachment plate into and out of a bulk storage container;
a follower plate affixed to the attachment plate to move with the attachment plate as the attachment plate is selectively moved by the press, the follower plate having an adapter receiver; and
an adapter removably seated in the receiver, the adapter including a secondary container interface configured to interconnect with a secondary container into which a fluid is to be transferred, the adapter defining a through-hole through which a fluid contained in a bulk storage container may pass into a secondary container interconnected with the adapter as the follower plate is moved into a bulk storage container by the press.

22.-23. (canceled)

24. The fluid transfer apparatus of claim 21,
wherein the receiver is recessed into a face of the follower plate;
wherein the receiver includes a plurality of throughways and slots, the adapter including a plurality of ears configured to be fitted into the slots to interscorer the adapter to the follower plate.

25. The fluid transfer apparatus of claim 24 wherein the adapter includes a cartridge port and a piston nest.

26. The fluid transfer apparatus of claim 25 wherein the adapter includes a generally circular head portion and a tail portion extending from the head portion.

27. The fluid transfer apparatus of claim 26 wherein the cartridge port is disposed in the head portion and the piston nest is disposed in the tail portion.

28. The fluid transfer apparatus of claim 27 wherein the tail portion includes a pair of lugs disposed adjacent to the piston nest.

29. The fluid transfer apparatus of claim 28 wherein the tail portion includes a ledge adjacent to the piston nest.

30. The fluid transfer apparatus of claim 21 wherein the adapter includes a hose and a spigot.

31.-32. (canceled)
